(19) United States
(12) Patent Application Publication
(10) Pub. No.: US 2003/0182751 A1
(43) Pub. Date: Oct. 2, 2003

(54) Faux painting tool

(76) Inventor: Barth White, N. Las Vegas, NV (US)

Correspondence Address: QUIRK & TRATOS, 3773 HOWARD HUGHES PARKWAY, SUITE 500 NORTH, LAS VEGAS, NV, 89109, US

(21) Appl. No.: 10/109,932

(22) Filed: Mar. 29, 2002

(51) Int. Cl. B05C 17/00

(52) U.S. Cl. 15/244.3; 15/144.1; 15/209.1; 15/210.1; 15/228; 15/231; 15/244.2; 15/247

(57) ABSTRACT

A faux painting tool includes a tubular handle, planer body and an application surface. The handle is rotatable and extendable to provide versatility and user comfort. The handle rotates about a first end having a circular dowel rotatably engaged by two spaced parallel couplings. A second end of the handle is removably engaged by a semi-circular carrier member having an opening for insertion of a portion of the handle. A telescoping elongated unit is slidably positioned over the tubular handle. Pressing spring biased pins permits the telescoping unit to be adjusted along a length of the tubular handle thereby lengthening the handle. A handle end includes a threaded aperture for receiving a threaded pole extension. Application material, including lamb's wool, is removably attached to a body of the tool by means of hook and loop fasteners attached to the material and a back surface of the tool's body.

### FIELD OF INVENTION

This invention is in the general field of faux painting. More particularly, a faux painting tool provides a means for creating decorative painted effects while allowing a user many options, including a rotatable handle, extendable handle and interchangeable faux painting surfaces.

### DESCRIPTION OF THE PRIOR ART

Faux or “false” painting is a method of creating an illusion through the use of paints and glazes. The desired result of faux painting is the creation of a natural appearing surface such as marble, granite, stucco or suede on a painting surface such as a wall or ceiling. The method of applying the paint and glazes has traditionally been accomplished by means of paint brushes, blending tools, paint rollers and related items. Additionally, various materials, including wool, carpet, newspaper and any material with a texture, are used to apply paints and glazes in an attempt to create unique painting effects.

Unfortunately, faux painting has also been traditionally complicated and time consuming. Therefore, there exists a need to provide an artisan with a simple, reliable and versatile tool for achieving desired faux effects without requiring the artisan to follow complicated time-consuming steps. Several patents attempt to address the complications and time requirements of traditional faux painting, but have been primarily unsuccessful.

U.S. Pat. No. 4,919,975 (the '975 Patent) discloses an applicator structure for providing a painted marbleized finish on an exposed wall or ceiling. The applicator is clearly illustrated in FIG. 12 of the '975 Patent. The applicator is simply a handle having a head portion, over which a boot is placed. The boot is formed of a flexible material that is used to apply paint to a desired surface. The '975 Patent suggests using an applicator in each hand to minimize the time of creating the marbleized finish. The applicator design disclosed in the '975 Patent lacks versatility and is not user friendly.

U.S. Pat. No. 5,866,206 (the '206 Patent) discloses a blending tool designed to produce faux style painting results. FIGS. 3, 6, 9, 11 and 12 show the blending tool is various situations. The blending tool includes a handle extending from, and attached to, a planar body. A front surface of the body is covered with a wool cover which extends around and partially covers a rear surface of the body adjacent the handle. The wool surface is used to pat the applied paints thereby creating the desired transitions of colors and illusionary textures. The blending tool disclosed in the '206 Patent lacks the features, namely a rotatable handle, extendable handle and interchangeable application surfaces, of the present invention.

The present invention is a faux painting tool designed to be versatile and easy to use. The present invention incorporates a rotatable and extendable handle maximizing the comfort of the tool. The handle further includes means for attaching said tool to a pole for maximizing the reach of the tool. Moreover, a material for applying paint (e.g. lamb's wool) is removably attached to a panel of said tool by means of hook and loop fasteners or the like. Additional materials (e.g plastic, terry cloth, etc.) can be easily layered over the lamb's wool, or used independently, to create an infinite number of faux painting effects.

### SUMMARY OF THE INVENTION

An object of the present invention is to provide a versatile and easy to use faux painting tool.

Another object of the present invention is to provide a faux painting tool with a rotatable and extendable handle.

Another object of the present invention is to provide a faux painting tool with means for attaching the same to a pole permitting a user to reach ceilings and other remote painting surfaces.

Another object of the present invention is to provide a faux painting tool with easily interchangeable paint application materials.

A further object of the present invention is to provide a faux painting tool comfortable for use by a majority of users.

Accordingly the present invention includes a generally rectangular planer body having a handle connected to one side thereof. The handle can be used in a traditional fashion or can be rotated for user comfort and versatility. The handle may also be extended. The extension means also permits the tool to reach more locations. One end of the handle having means for accepting a pole provides maximum reach for the faux painting tool.

The handle is formed of a first end, including an elongated circular dowel connected thereto, said circular dowel is rotatably engaged by a pair of spaced parallel couplings of a first support member extending from a back surface of the planer body and a second end having an telescoping unit removably engaged within a carrier member of a second support member extending from the back surface of said planer body. Preferably, the handle and its telescoping unit are circular in cross-section for user comfort. In addition, the carrier member is semi-circular having an opening for insertion of the second end of said handle such that the carrier member engages the second end of the handle. In this arrangement, the second end of the handle may be released from engagement, and rotated about its first end, by applying moderate pressure adjacent the second end of the handle and directed toward the carrier member opening.

The body of the faux painting tool includes strips of hook and loop fasteners, preferably Velcro®, along two or more edges of the back surface. A paint application material, such as lamb's wool, is fitted to cover an entire front surface of said body and wrap around the edges thereof. Once wrapped around the edges of the body, hook and loop fastener strips on an underneath surface of the application material correspond to the strips on the back surface of the body and join the application material thereto.

Means of layering other application materials over the lamb's wool material are considered by the present invention. More particularly, a plastic material including an elastic-type border is easily placed over the lamb's wool. Moreover, additional materials (e.g. terry cloth) may be integrated between the lamb's wool and the plastic and held in place by the plastic removably placed over the lamb's wool. In this fashion, any number of material combinations can be utilized to create the desired faux painting effects.

### BRIEF DESCRIPTION OF THE DRAWINGS

FIG. 1 is a perspective view of the present invention with the application material removed therefrom;

FIG. 2 is a perspective view of the present invention with the application material attached thereto;

FIG. 3 is an underside view of a lamb's wool application material (application material removed);

FIG. 4 is a top view of the present invention (application material removed);

FIG. 5 is a side view illustrating an engaged handle of the present invention (application material removed);

FIG. 6 is a side view illustrating a first end of the handle of the present invention in a non-rotated position (application material removed);

FIG. 7 is a side view illustrating a second end of the handle of the present invention in an engaged position (application material removed);

FIG. 8 is a side view of the present invention along the handle illustrating the handle of the present invention in a rotated and partially extended position (application material removed); and

FIG. 9 is a cross-sectional view of the present invention along line A of FIG. 2 illustrating a combination application surface of lamb's wool, terry cloth and plastic.

### DESCRIPTION OF THE EMBODIMENTS

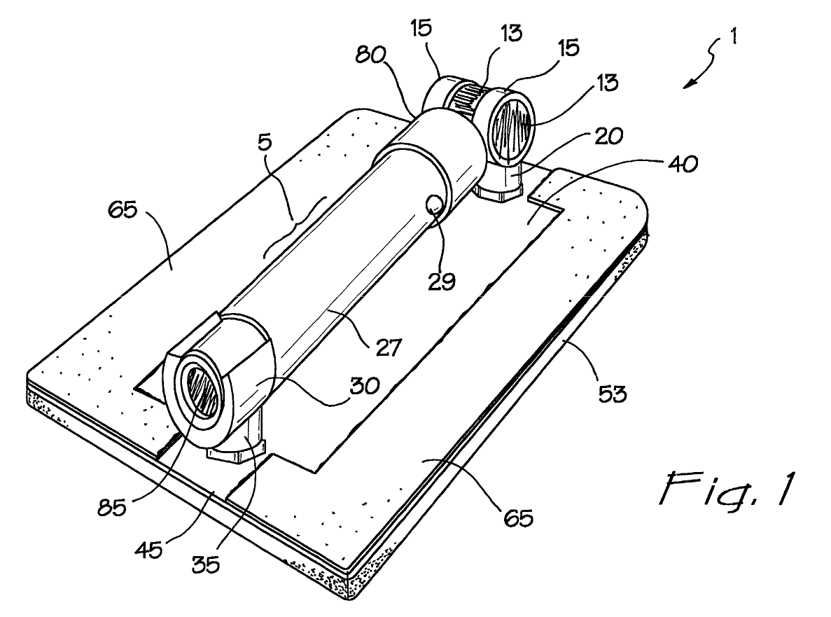

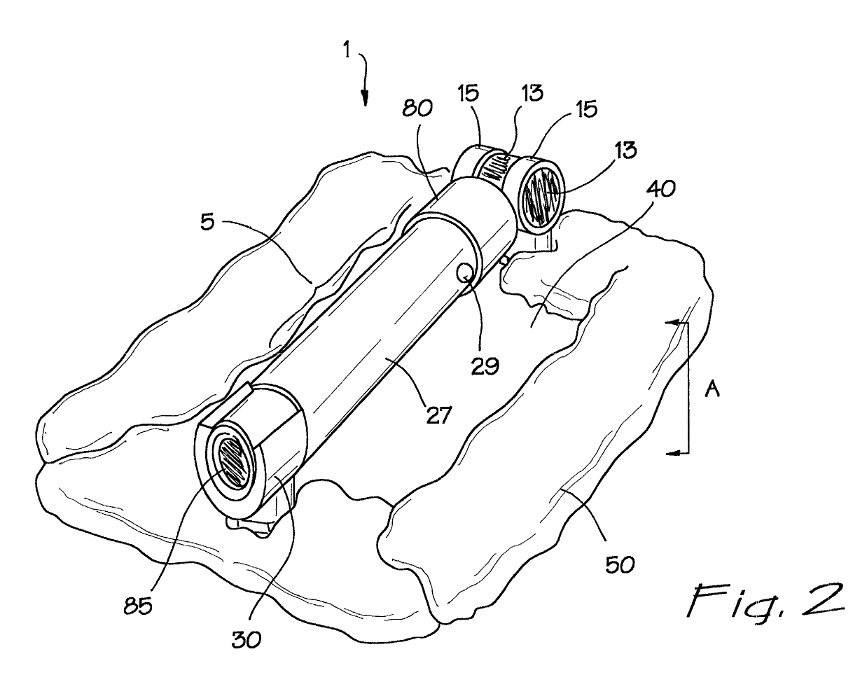

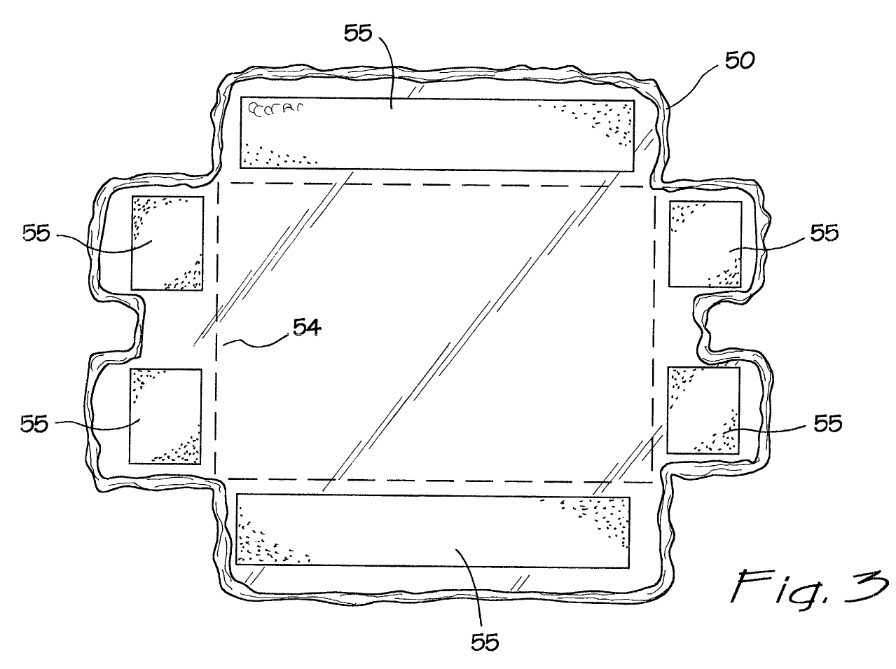

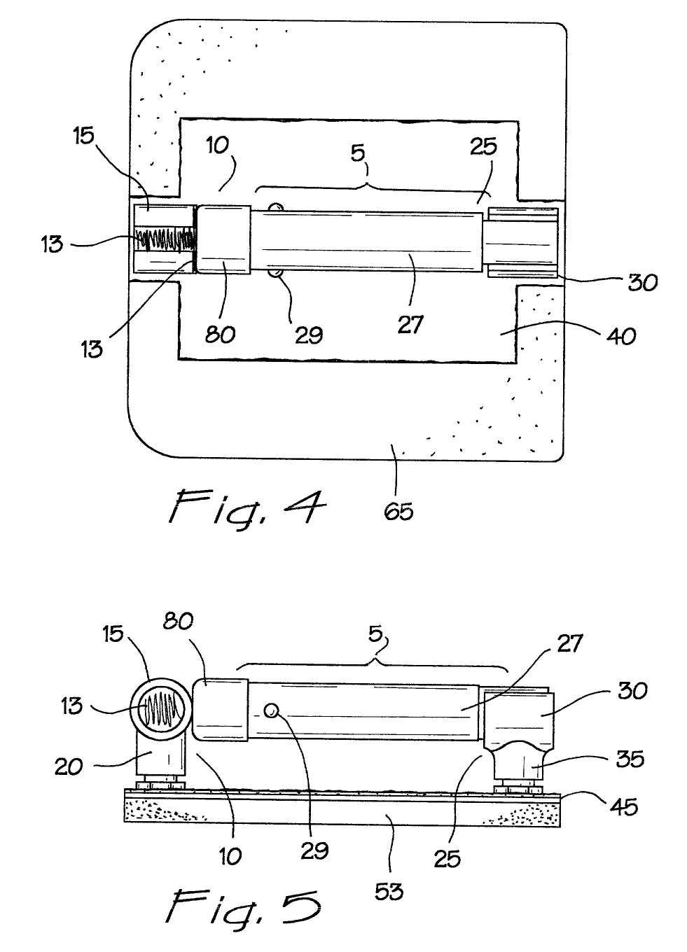

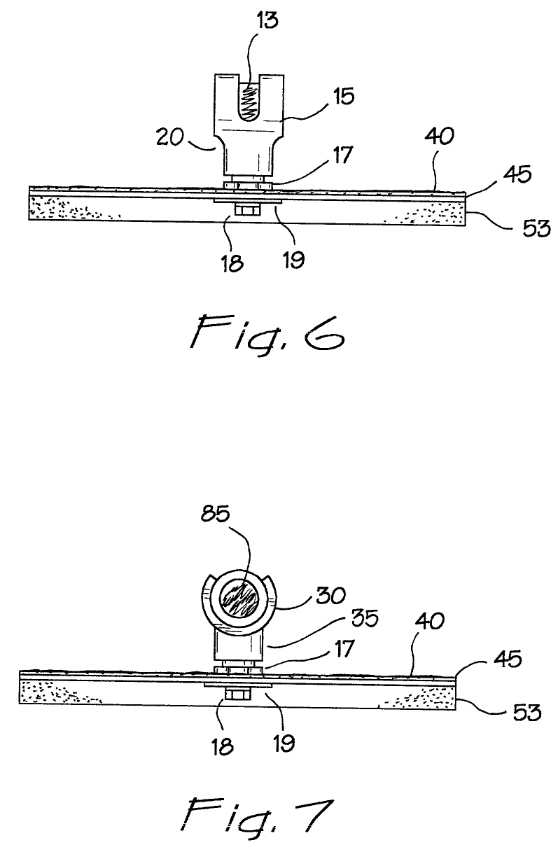

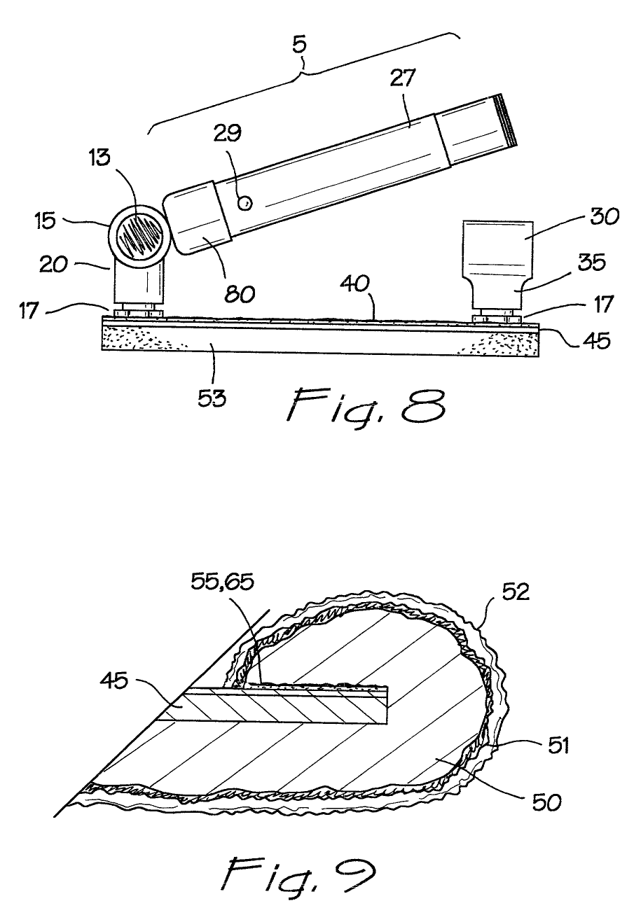

Reference is now made to the figures wherein like parts are referred to by like numerals throughout. Referring to FIGS. 1 and 2 the faux painting tool generally referred to as 1, includes a handle 5 with a first end 10 connected to a dowel 13 of circular cross-section rotatably engaged by a pair of spaced parallel couplings 15 integrated with a first support member 20 and a second end 25 removably engaged within a semi-circular carrier member 30 integrated with a second support member 35. Each of the support members 20, 35 extend from a back surface 40 of a planer body 45 of the faux painting tool 1.

An lamb's wool application material 50 is shown in FIG. 3 having hook and loop fastener strips 55 fixed to an underneath surface 60 thereof. Hook and loop fastener strips 65 fixed to the back surface 40 correspond to the hook and loop fasteners 55 and provide a means for removably attaching the material 50 to the body 45 of the tool as shown in FIG. 2. The pattern illustrated allows the application material 50 to be integrated around corners and the support members 20, 35 on the back surface 40 of the body 45. Perimeter fold lines 54 depict the portion of the application material 50 that will be placed adjacent a front surface of the body 45. Once in place, the material 50 covers a front surface 70 of said body 45 and extends over the edges 75 of said body 45 where it removably attaches to the back surface 40 of the body 45. Preferably, a piece of semi-rigid foam 53 resides between the body 45 and the application material 50 so as to act as a buffer between the application material 50 and the rigid body 45.

Now referring to FIGS. 4 and 5, the handle 5 is shown while in a secured position. In other words, the second end 25 of the handle 5 is engaged by the carrier member 30. The carrier member 30 is semi-circular in cross-section having an opening for the second end 25 of the handle 5 to insert through such that the carrier member 30 partially contains the second end 25. The carrier member 30 is preferably made of flexible plastic such that the second end 25 may be easily inserted into, and removed from, the carrier member 30 through said opening. However, the plastic should be rigid enough to adequately secure the handle 5 in place when said second end 25 is engaged by said carrier member 30. In this arrangement, the width of the opening is less than the diameter of the second end 25 insuring that the second end 25 is secured within the carrier member 30.

A telescoping unit 27, in the form of a hollow tube, is slidably positioned over handle 5. Spring biased pins 29 inserted through apertures in the handle 5, and corresponding apertures in said telescoping unit 27, provide means for adjusting the telescoping unit 27 in the traverse direction along a length of the handle 5. Pressing the pins 29 toward one another permits the telescoping unit 27 to move freely along an outer surface of the hollow-tubed handle 5.

The first end 10 of the handle 5 includes a circular dowel 13 rotatably engaged by two parallel couplings 15 fixed to a first support member 20. The first end 10 of the handle 5 is inserted into a cap 80 which, along with the first end 10, is connected to the circular dowel 13 by means of an active screw 14. A second remotely located support member 35 supports the carrier member 30.

FIG. 6 illustrates the side view of the present invention in the direction of the first end 10 of the handle 5. The couplings 15, supported by the first support member 20, is shown rotatably engaging the circular dowel 13. FIG. 6 also shows a nut 17, bolt 18 and washer 19 arrangement for securing the first support member 20 to the body 45.

FIG. 7 illustrates the opposite side view of FIG. 5 thereby showing the second end 25 of handle 5 engaged by the carrier member 30. Also shown is nut 17, bolt 18 and washer 19 arrangement for securing said second support member 35 to the body 45. A threaded aperture 85 in an open end of the telescoping unit 27 is designed to receive a threaded end of a pole extension (not shown) for maximizing the reachable locations of the faux painting tool 1.

Now referring to FIG. 8, the handle 5 of the faux painting tool 1 is illustrated in a rotated and extended position. The rotation of the handle 5 is accomplished by turning the handle 5 counter-clockwise thereby turning screw 14 and relieving friction between the cap 80 and the parallel couplings 15. Thereafter, once the handle 5 is rotated to a desired position, the handle 5 is turned clockwise thereby creating friction between the cap 80 and the parallel couplings 15. The friction holds the handle 5 securely in place until a user desires to move the handle 5 to a new position. The method of extending the handle 5 is described above.

FIG. 9 shows a cross-sectional view of the faux painting tool 1. More particularly, the cross-sectional view illustrates a multi-layered application surface including application material 50. The multi-layered application surface is formed of a layer of the application material 50, preferably lamb's wool, an intermediate layer of terry cloth 51 and outer layer of plastic 52. The plastic includes an elastic border for wrapping the plastic 52 over the lamb's wool, terry cloth and around the edges 75 of the body 45. A piece of semi-rigid foam 53 resides between the body 45 and the multi-layered application surface. The plastic 52 is similar in design to a shower cap in that it contains the semi-rigid foam 53, application material 50 and terry cloth 51. This layered arrangement provides a unique faux painting design. This is but one combination of materials suitable for use with the present invention.

Although the invention has been described in detail with reference to a preferred embodiment, additional variations and modifications exist within the scope and spirit of the invention as described and defined in the following claims. By way of example, the screw 14 can be replaced with any connection means permitting said handle 5 to be distanced from said couplings 15 and vice versa.

I claim:

1. A faux painting tool comprising:
a planer body;
an elongated handle having a first and second end;
a first support member having a coupling means and a second support member having a carrier member, said support members extending from a back surface of said planer body, said first end of the handle being rotatably engaged by said coupling means and said second end of the handle being removably engaged by the carrier member; and
an application material covering a front surface of said planer body, said material extending over two or more edges of the planer body and being removably attached to the back surface of said planer body.

2. The faux painting tool according to claim 1 wherein said handle is tubular.

3. The faux painting tool according to claim 1 wherein said second end of the handle includes a threaded aperture for receiving an extension pole having a threaded end.

4. The faux painting tool according to claim 1 wherein the coupling means includes two spaced couplings rotatably engaging a circular dowel connected to the first end of said handle.

5. The faux painting tool according to claim 2 wherein an telescoping tubular unit is slidably positioned over said tubular handle.

6. The faux painting tool according to claim 1 wherein said application material is connected to said back surface of said planer body by means of hook and loop fastener strips attached to said application material and corresponding hook and loop fastener strips attached to the planer body.

7. The faux painting tool according to claim 1 wherein the application material is comprised of one or more materials selected from the group consisting of lamb's wool, terry cloth and plastic.

8. The faux painting tool according to claim 1 wherein a semi-rigid foam material is placed between the application material and the front surface of the planar body.

9. A tool for creating decorative false effects on a painting surface including:
a planer body;
an elongated telescoping tubular handle;
means for rotatably securing said handle to a back surface of the planer body; and
an application material covering a front surface of said planer body, said material extending over two or more edges of the planer body and being removably attached to the back surface of said planer body.

10. The tool according to claim 9 wherein the means for rotatably securing said handle includes a first support member having a coupling means and a second support member having a carrier member, said support members extending from a back surface of said planer body, a first end of the handle being rotatably engaged by said coupling means and a second end of the handle being removably engaged by the carrier member.

11. The tool according to claim 10 wherein said second end of the handle includes a threaded aperture for receiving an extension pole having a threaded end.

12. The faux painting tool according to claim 10 wherein the coupling means includes two spaced couplings rotatably engaging a circular dowel connected to the first end of said handle.

13. The tool according to claim 9 wherein said application material is connected to said back surface of said planer body by means of hook and loop fastener strips attached to said application material and corresponding hook and loop fastener strips attached to the planer body.

14. The tool according to claim 9 wherein the application material is comprised of one or more materials selected from the group consisting of lamb's wool, terry cloth and plastic.

15. The faux painting tool according to claim 9 wherein a semi-rigid foam material is placed between the application material and the front surface of the planar body.
